(19) United States
(12) Patent Application Publication
(10) Pub. No.: US 2007/0187323 A1
(43) Pub. Date: Aug. 16, 2007

(54) Environmental Waste Water Cultivation System

(76) Inventor: James Arnold Williams JR., Queenstown, MD (US)

Correspondence Address: James A. Williams Jr, 2116 Bennett Point Road, Queenstown, MD, 21658-1115, US

(21) Appl. No.: 11/307,516

(22) Filed: Feb. 10, 2006

(51) Int. Cl. C02F 3/30; B01D 21/02; B01D 21/30

(52) U.S. Cl. 210/532.2; 210/602

(57) ABSTRACT

The Environmental Waste Water Cultivation System is specifically designed without drainage or discharge facilities, to protect viable environments, including hydraulic systems. This system receives solid and aqueous waste and limits the amount of precipitation or condensation in an “on-demand” and variable fashion, to stabilize the system instantaneously and produces useable biomass. This system produces no discharge at any time and will function in any climate, every month.

Published reference: MARYLAND DEPARTMENT OF THE ENVIRONMENT GUIDELINES FOR LAND TREATMENT OF MUNICIPAL WASTEWATERS, MDE-WMA001 -07/03

The patent reference material was qualified by searching for patents containing: the following keyword relationships:

inlet and waste and water and liner and (outlet or discharge) and evaporation and (cap or cover), yielding the following:

| | | |
|---|---|---|
| 1 | 20030024874 | System and method for removing pollutants |
| | | from water |
| 2 | 20020179511 | Biological waste water treatment system |
| 3 | 20020179510 | Biological waste water treatment system |
| 4 | 20020179509 | Biological waste water treatment system |
| 5 | 6,652,743 | System and method for removing pollutants |
| | | from water |
| 6 | 6,406,627 | Method for removing pollutants from water |
| 7 | 6,200,469 | System for removing pollutants from water |
| 8 | 6,041,738 | Fish pond methods and systems |
| 9 | 4,608,126 | Retorting system and disposal site |
| 10 | 4,529,497 | Disposal of spent oil shale and other materials |

In addition: the following reference patent material containing the following keyword relationships:

Method or process or program and waste and wastewater and (cover or cap) and transpiration and discharge, yielding the following:

| | | |
|---|---|---|
| 1 | 20040249505 | Method and system for water management |
| 2 | 6,159,371 | Constructed wetlands remediation system |
| 3 | 5,863,433 | Reciprocating subsurface-flow constructed |
| | | wetlands for improving wastewater treatment |
| 4 | 5,582,680 | Wastewater treating apparatus |
| 5 | 5,121,708 | Hydroculture crop production system |
| 6 | 4,765,822 | Recovery of fluorine from waste gases |
| 7 | 4,623,528 | Recovery of fluorine from waste gases |
| 8 | 4,613,494 | Recovery of fluorine from waste gases |

However, the following reference material specifications containing the following keyword relationships: Transpiration and (septic or Landfill) and discharge, yields the following:

| | | |
|---|---|---|
| 1 | 6,858,142 | Polluted water treatment system |
| 2 | 6,749,368 | Design, monitoring and control of soil carburetors for |
| | | degradation of volatile compounds |
| 3 | 6,652,743 | System and method for removing pollutants from water |
| 4 | 6,592,761 | Biological waste water treatment system |
| 5 | 6,569,321 | Method and apparatus for treating stormwater runoff |
| 6 | 6,485,647 | Method and apparatus for treating leach fields |
| 7 | 6,467,994 | Apparatus and method for beneficial use or handling |
| | | of run-off or collected water |
| 8 | 6,428,691 | Biological waste water treatment system |
| 9 | 6,406,627 | Method for removing pollutants from water |
| 10 | 6,277,274 | Method and apparatus for treating stormwater runoff |
| 11 | 6,264,838 | On site waste water recycling system |
| 12 | 6,250,237 | Method for using tree crops as pollutant control |
| 13 | 6,200,469 | System for removing pollutants from water |
| 14 | 6,178,691 | Capillary carpet irrigation system |
| 15 | 6,139,221 | Constant hydraulic head moat and method for controlling |
| | | regional ground water flow |
| 16 | 5,836,716 | Drainage pipe |
| 17 | 5,766,475 | Waste water disposal system |
| 18 | 5,520,481 | Drain field system |
| 19 | 5,516,229 | Drain field system |
| 20 | 5,442,293 | Method and apparatus for determining fluid content and |
| | | conductivity in porous materials |
| 21 | 5,183,355 | Method of draining water through a solid waste site |
| | | without leaching |
| 22 | 5,163,780 | Method of modifying the soil permeability for |
| | | septic systems |
| 23 | 4,002,561 | Method and apparatus for aerobic sewage treatment |

All previously sited references require an inlet and an outlet.

(Method or process or program) and waste and wastewater and (cover or cap) and transpiration and (“no discharge” and “no outlet”), yields no results

As well as:

inlet and waste and water and liner and (“no outlet” or “no discharges”) and evaporation and (cap or cover) and transpiration, yields no results.

### BACKGROUND OF THIS ART

The utilization of our passive resources is the key to the Environmental Waste Water Cultivation System.

The primary energy source is solar; the secondary energy source is heat absorbed from the residence or commercial structure, and transferred to the Environmental Waste Water Cultivation System.

Wastewater processing includes effluent isolation, horticultural root zone respiration, and horticultural transpiration.

Currently, all septic systems include the release of effluent to ground and natural hydraulic systems (rivers, creeks, etc.) that eventually can decimate marine life. The Environmental Waste Water Cultivation System will not do this. Captured effluent or enumerated wastewater is completely consumed by the system's horticultural elements.

### SUMMARY OF THE PROCESS

The mass flow of wastewater, per unit of time, to be processed will determine the total volume of horticultural elements. In addition, unobstructed solar-impacted surface area is required and is determined by the horticultural elements' (crop) coefficient(s) and geographically dependant evapotranspiration rates published by meteorological concerns.

Therefore, any amount of wastewater can be processed when sufficient solar irradiated surface area is available and suitable horticultural elements are selected.

Rooting media (types of loam) is selected to affect the best wastewater processing characteristics for the selected horticultural elements.

This system is composed of a septic tank, emergency water pumping chamber, septic water pumping chamber, and a capped and contained distribution field.

With the subject effluent rate secured and horticultural requirements determined, I will be able to properly “size” the Environmental Waste Water Cultivation System's surface area.

Using this data, I calculate the total surface area required to process subject influent rate. The resulting volumetric is augmented to account for loam media, horticultural elements, and storage quantities.

This effluent containment is considered virtually impervious to groundwater and rainwater and can be semi-submerged to enable emergency water application to horticultural media and elements. As a standard, the storage capacity will be for more than 3 months.

The only water captured in this system is the water used within the residence or commercial structure and initially, a maximum of 12% of precipitation. To insure containment of influent, the landfill liner and capping material is Geosynthetic Clay Lining (GCL). The Lining consists of bentonite (clay), bonded to an impervious polymeric sheet. The benefit of using this type of material is that it is self-healing. Laboratory tests have shown that bentonite clay is able to self-heal holes that are 75 millimeters in diameter. In addition, its hydraulic conductivity is less than one billionth of a centimeter per second.

Therefore, this system is required to have a minimum base of:

1 Foot of clay or other natural material having an in-place permeability of less than or equal to 1×10⁻⁷ centimeters/second.

One or more unreinforced synthetic membranes with a combined minimum thickness of 50 mil.

A single reinforced synthetic membrane with a minimum thickness of 30 mil, which has a permeability less than or equal to 1×10⁻¹⁰ centimeters/second, placed over a prepared subbase with a minimum thickness of 2 feet and a permeability less than or equal to 1×10⁻⁵ centimeters/second.

The cap will consist of material having an in-place permeability of less than or equal to 1×10^{31 5} with damming collars and surface water diverters to prevent runoff from entering the system. The sub-cap should consist of 2″-3″ stones, 6 inches in depth to facilitate system gas exchange and a metered precipitation introduction rate of 12% of precipitation.

Stormwater pond to store excess stormwater.

The system distribution utilizes subterranean irrigation techniques that prevent root and salt obstruction in nourishing horticulture elements in appropriate intervals/rates.

The crux of system maintenance is sufficient nutrient and water supply. All horticultural elements are robust under these circumstances.

System failure indications are:

Escaped effluent from cap.

In the event of cap or liner failure, re-evaluate wastewater flow rates, which must be done by the system designer at no additional cost, to insure that the containment design is sufficient and make commensurate alterations within physical constraints; this must be done by the system designer. Or, if the system is appropriately sized per the original building plans, install additional bentonite clay or other flexible membrane to repair the source of effluent breach and arrangements must be made for the removal of excess effluent by licensed septic handling professionals at the expense of the property owner. If the effluent rate outgrows the size of the system, and additional irradiant area on the subject property is not available, the owner will need to contract an authorized septic handling and removal company for periodic removal that would eliminate the event of overflow. In the long-term, the owner may need to vacate the property or reduce the effluent rate.

Expired horticultural elements

In the event of element failure, the failed element will be replaced with an equivalent element(s) with equal or greater root mass, at the expense of the liable party.

Observation of horticultural elements and the content of the inspection wells is the primary means of inspection.

Automatic controls with thresholds to maintain stability under lower and high effluent rates are as follows:

Control system to address varied influent rates

Pump effluent from the isolated System to the effluent Holding Tank if the water capacity of the Isolated System exceeds or is equal to 80%

Pump from the Water Holding Tank to the Isolated System, if the water capacity of the Isolated System falls to or below 60%

Emergency Pumping from the Isolated System, by a licensed septic hauler, if the content of the effluent Holding Tank exceeds 85%

Emergency Pumping from the Water Holding Tank, supplied by private well or a by a licensed water hauler, to the Isolated System, if the content of the Isolated System fails below 55%

Maryland Department of the Environment Monitoring Design:

The peripheral monitoring system produces groundwater flow direction and a way to determine the contemporaneous groundwater quality. The existing groundwater quality would serve as a basis for later comparison. Analysis includes dissolved solids, nitrate, total phosphorus, and total nitrogen.

To detect groundwater contamination, the monitoring wells consist of the following:

At least two wells, adjacent to the property line, down-gradient from the cultivation site, which are screened from the seasonally high groundwater table downward 15 feet.

Monitoring wells (at least one) completed in an area up-gradient from the disposal site so that it will not be affected by potential contaminants.

Each monitoring well will be constructed utilizing 4″ I.D., schedule 40, PVC pipe or casing

The well shall be gravel-packed to at least five feet above the top of the screen unless multiple aquifers are affected.

The screened interval must consist of at least 15 feet of schedule 40, 4″ (103 mm), and slotted PVC well screen.

Wells will penetrate a minimum of 15 feet below the groundwater table.

The well will be continuously pressure grouted from top of gravel pack to ground surface. The well shall also be developed and disinfected prior to sampling.

Whenever the original monitoring network indicates groundwater degradation, immediate steps will be taken to determine cause and if necessary the corrective measures taken, as stated previously. These measures may include construction of additional wells to determine lateral and vertical extent of contamination direction, rate of movement, dilution and attenuation, etc. Further quantitative studies can be performed to determine the exact nature of contamination. These studies will aid in determining the proper corrective measures needed to abate the problem.

Well Sampling

Three volumes of stagnant water are pumped out prior to taking samples. Withdrawal methods may include pumps, compressor air, or boilers according to guidelines and techniques outlined in EPA's Procedures Manual for GW Monitoring at S.W. Disposal Facilities pp. 220-237 Sample Withdrawal, Storage and Preservation is helpful.

Monitoring Frequency

Monitoring frequency for a cultivation site may be influenced by a number of factors and thus will be addressed on a case-by-case basis but at a minimum of once per three (3) months, conducted by the system designer.

System Performance

The hydrologic expression is as follows:
P+Lw=ET+GW+RO+SM

Where:

=natural precipitation occurring on-site. For design purposes, the wettest year in the last 10 years of record should be used.

Lw=amount of wastewater applies to site.

ET=evapotranspiration losses from site.

GW=amount of water entering groundwater system beneath site.

SM amount of moisture contained in soil profile on site.

RO=amount of surface runoff flowing from site.

The nature of this system requires modification to the hydrologic expression which promotes stability.

RO=0.88P; due to the installation of a metered cap

GW=negligible; approaching 0, due to the installed system liner.

Therefore, the hydrologic expression, inside this system becomes as follows.
P+Lw=ET+0.88P+SM

In summation, this system is governed by the following expression:
0.12P+Lw=ET+SM

However, this system is dynamic and requires particular attention paid to fluid rates and evaporation rates over time. Therefore, all of the components become functions of time. The equation's component rates and their relationships, with regard to the moisture content of the soil profile, are as follows:

The Equation is as follows: d[SM(t,area,source)]/dt=K₁/8.333*d[P(t,area)]/dt+K₂*d[Lw(source)]/dt−K₃*d[ET(t,area)]/dt, where K₁, K₂, K₃ are site specific coefficients.

As stated earlier, precipitation introduced to the system is metered with an initial maximum amount, not to exceed, twelve percent (12%) of precipitation with the use of a metered cap.

Optimizing the above equation yields the transpiration model and design module.

Referring to the report, MARYLAND DEPARTMENT OF THE ENVIRONMENT GUIDELINES FOR LAND TREATMENT OF MUNICIPAL WASTEWATERS, MDE-WMA-001-07/03, Revision Date: July 2003, “the runoff term (RO) in the previous hydrologic balance is usually omitted. Soil moisture changes, gains and losses, on an annual basis are thought to balance each other out. Consequently, soil moisture (SM) from year to year is considered relatively constant and, therefore, usually omitted from the hydrology equation. However, this system has a soil moisture content ranging from sixty (60) percent to seventy-three (73) percent.

The report also states, “The precipitation and temperature data required for the hydrologic balance can be obtained from regional climatological stations owned and operated by the Weather Bureau, U.S. Department of Commerce. These climatic stations are established throughout the continental U.S., and the data published monthly. The precipitation data (P) is directly used in the equation. The temperature data, along with the precipitation data, is used to calculate the potential evapotranspiration term (ET) in the equation. There are several methods commonly used to calculate potential ET. Most of them can be found in basic hydrology texts.”

Where this system is an improvement over of the systems enumerated in,” MARYLAND DEPARTMENT OF THE ENVIRONMENT GUIDELINES FOR LAND TREATMENT OF MUNICIPAL WASTEWATERS, MDE-WMA-001-07/03, is the actual metering of water and nutrient, including specifically, precipitation, to an isolated system. In addition, the horticultural candidates, i.e. Silva cultural candidates, are able to consume large quantities of solids and water over long periods of time, 20-30 years, without harvesting.

MARYLAND DEPARTMENT OF THE ENVIRONMENT GUIDELINES FOR LAND TREATMENT OF MUNICIPAL WASTEWATERS, MDE-WMA-001 -07/03, Environmental data.

TABLE 1

| Month | Natural Precipitation. (inches) | Potential ET (inches) |
|---|---|---|
| October | 2.63 | 2.74 |
| November | 2.29 | 1.90 |
| December | 3.04 | 1.44 |
| January | 2.57 | 1.29 |
| February | 2.10 | 1.29 |
| March | 3.08 | 2.08 |
| April | 2.98 | 2.96 |
| May | 3.76 | 4.03 |
| June | 3.01 | 4.58 |
| July | 3.45 | 4.93 |
| August | 3.25 | 4.07 |
| September | 3.46 | 3.63 |

Month Natural Precipitation (Inches) Wastewater loading (inches) Potential ET (inches) Entering Groundwater (inches), where 1 acre - in=27,000 gallons of water.

Below is the system requirement for a commercial/retail complex, 60,000 gallons of effluent per day, located on the Eastern Shore of Maryland.

Input data includes the definition of maximum leakage rate, which is the semi-conduction of precipitation; rooting media water content percentage, rooting media porosity, effluent/wastewater production, and evapotranspiration statistics of the subject location.

Metered Cap Operation the “on-demand” Metered Cap, meters the amount of precipitation by opening shingled flaps or by a placing tension on the Metered Cap tension straps, at varied tensioned rates, causing the expandable holes to meter the amount of precipitation on-demand.

Once the constructed land is in place and the Metered Cap is installed, horticultural elements are inserted through the metered-cap, in such a way as to provide for a tight fit. The metered-cap material must be able to expand with trunk or stem growth.

Teaching of This method the application of horticultural components used as a specific component of an engineered mechanical system is unobvious. This patent will establish the concrete, scaleable, repeatable art of horticulture, integrated with mechanical engineering now named hortical engineering.

Enumerated Component List Follows:

(1) Water supply
(2) Commercial or Residence
(3) Effluent field supply distribution line
(4) Effluent Settling Tanks
(5) Effluent Distribution Lines
(6) Property Line
(7) Excess Effluent Holding Tank
(8) Excess effluent distribution line
(9) Horticultural elements
(10) Standby water holding tank
(11) Standby water supply distribution line
(12) Constructed Land liner
(13) Constructed Land Metered Cap
(14) Contained Constructed Land
(15) Constructed Land inlet
(16) Protected Land and Hydraulic Systems
(17) Horticultural root zone
(18) Inspection well
(19) Retaining Wall
(20) Expandable holes
(21) Metered Cap tension Straps

### DRAWINGS

FIG. 1 is an application of the Environmental Waste Water Cultivation System for a 60,000 gallon flow rate.

FIG. 2 is Constructed Land liquid content percentage

FIG. 3 is EWWCS Typical Plan and Elevation Views

FIG. 4 is EWWCS Typical Inlet Section

FIG. 5 is EWWCS Typical Emergency Water Inlet Section

FIG. 6 is EWWCS Metered Cap Overview

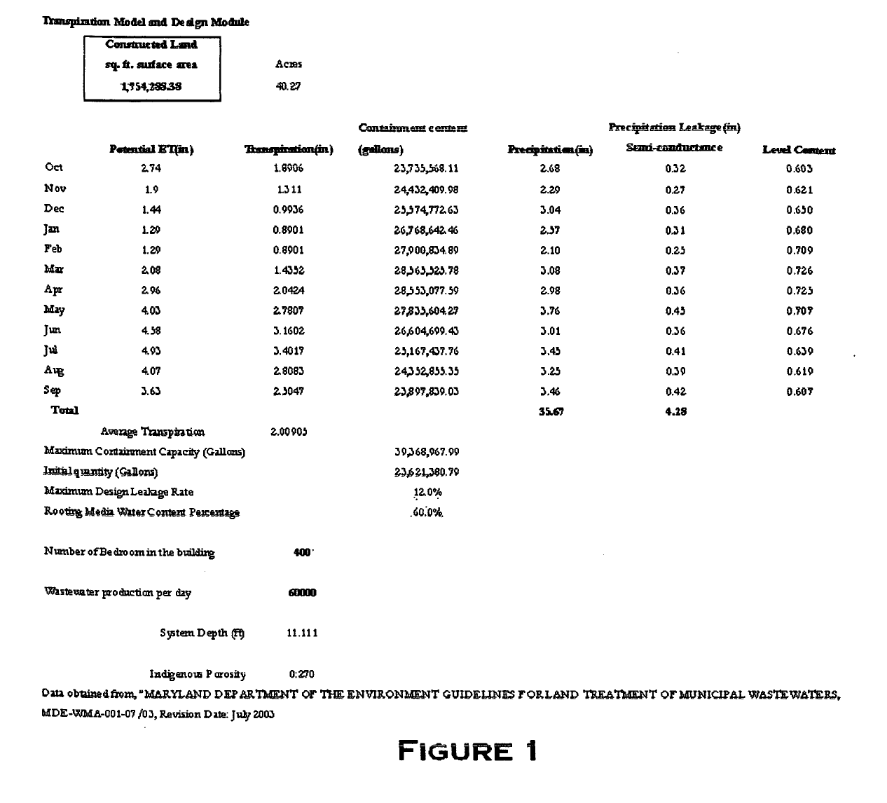

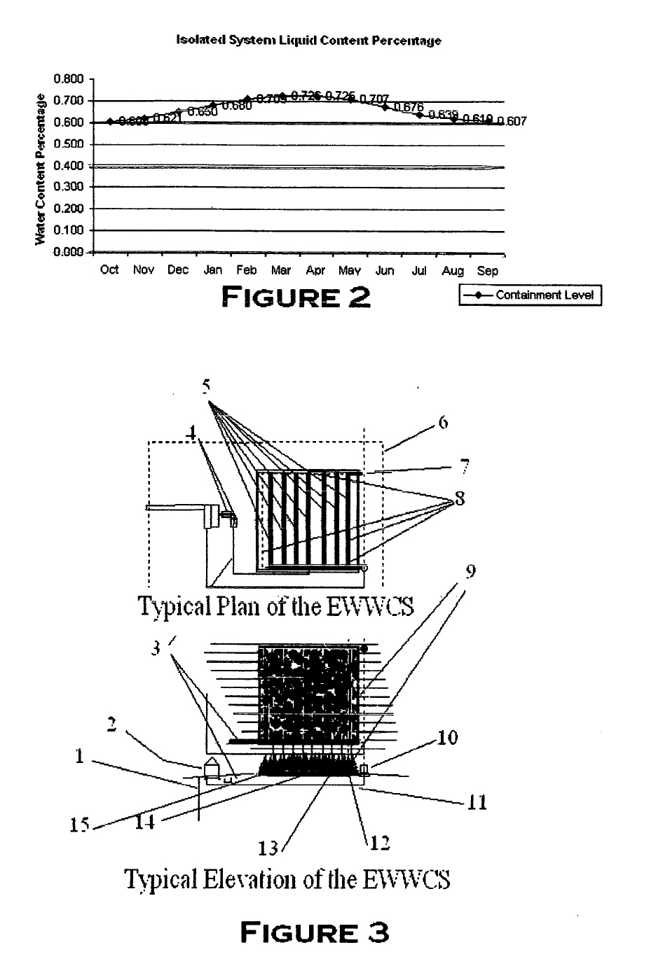

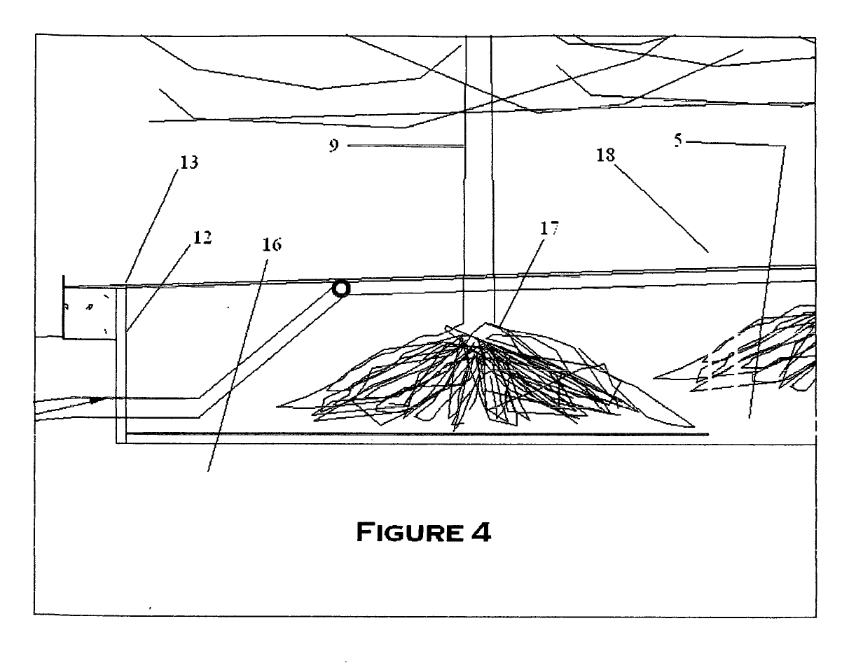

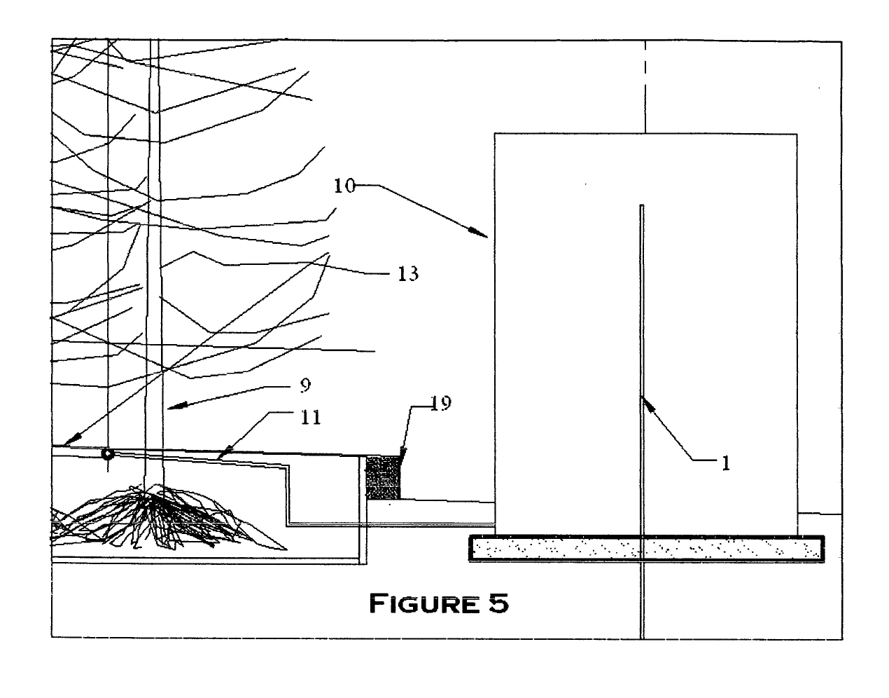

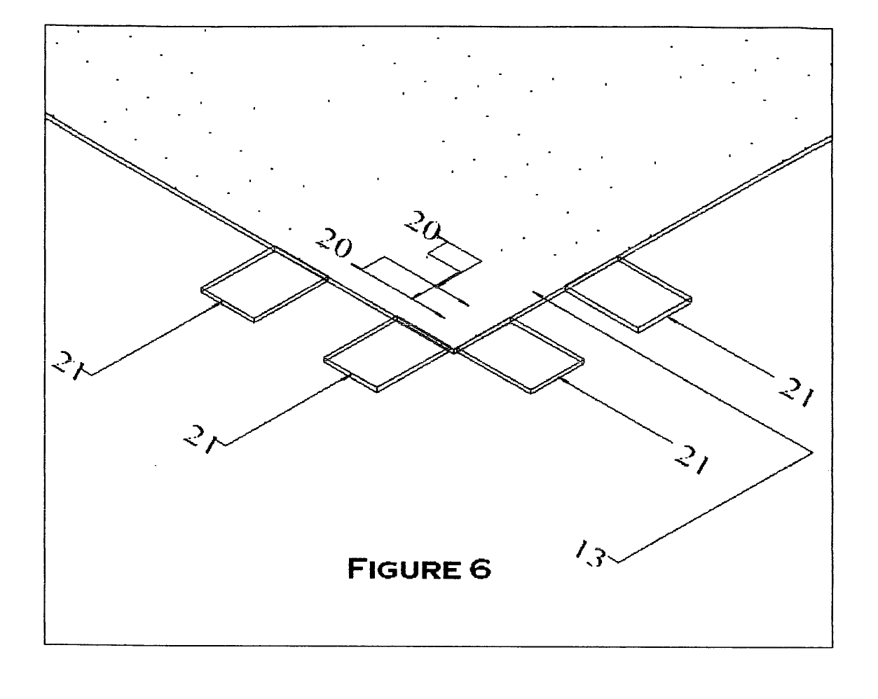

What is claimed is:

1. A specific wastewater processing system design program that determines the exact dimensions of a human and animal waste material distribution apparatus, a volume with inlets and no outlets which is able to isolate human and animal waste material influxes from viable environments and located in an area which is subjected to solar radiation and a cap to said volume which will not impede horticultural elemental growth while said cap is programmable, for variable percentages, 0 percent to 100 percent, of precipitation to gain access to said container interior on-demand and said program provides for emergency hydration means in the event of the suspension of human and animal waste materials influxes which is integrated with said program.
